(19) United States
(12) Patent Application Publication
(10) Pub. No.: US 2018/0213215 A1
(43) Pub. Date: Jul. 26, 2018

(54) METHOD AND DEVICE FOR DISPLAYING A THREE-DIMENSIONAL SCENE ON DISPLAY SURFACE HAVING AN ARBITRARY NON-PLANAR SHAPE

(71) Applicants: UNIVERSITE DE NANTES, NANTES (FR); CENTRE NATIONAL DE LA RECHERCHE SCIENTIFIQUE, Paris (FR)

(72) Inventor: Fabien PICAROUGNE, CARQUEFOU (FR)

(21) Appl. No.: 15/745,410

(22) PCT Filed: Jul. 18, 2016
(86) PCT No.: PCT/EP2016/067063

§ 371 Date: Jan. 16, 2018

(30) Foreign Application Priority Data
Jul. 17, 2015 (FR) 15 56810

(51) Int. Cl. H04N 13/332; H04N 9/31; G06T 3/00

(52) U.S. Cl. CPC H04N 13/0459; H04N 2013/0465; G06T 3/005; H04N 9/3185

(57) ABSTRACT

The invention relates to a method and to a device for displaying a three-dimensional scene on a display surface having an arbitrary non planar shape, for correct viewing by an user having a given position in a three-dimensional spatial reference system. The method comprises displaying a display image comprising pixels which represent the three-dimensional scene. The invention comprises:
a first step (A1) of projecting a three-dimensional model of the display surface onto a projection plane (P_{L}) in perspective, the projection in perspective having a projection centre which is dependent on the position of the user in the spatial reference system, making it possible to obtain a projection image (Iₚᵣₒⱼ) of the display surface from the point of view of the user; and
a second step (A2) of calculating a projection of the three-dimensional scene on the display surface using said projection image (Iₚᵣₒⱼ).

The present invention relates to a method for displaying a three-dimensional scene on an arbitrary non-planar shaped display surface for viewing by a user having a given position in a spatial reference system.

The invention lies in the field of computer graphics, in particular the projection of three-dimensional scenes used in immersive virtual reality systems.

Such systems are used, for example, for industrial, recreational or educational purposes.

Virtual immersion installations consisting of several screens are known to fully cover the user's field of view, allowing immersion in a universe of three-dimensional scenes. In order to simplify the graphic processing induced by the projection, the screens are generally flat and arranged next to each other. In order to maximize the user's field of vision, the screens are positioned to form a cube or a portion of a cube, for example in a CAVE (Cave Automatic Virtual Environment) installation. However, such an installation has visual defects at the angles joining the screens, which are perceived by the users as artifacts in the image of the projected scene.

To overcome these disadvantages, installations with curved screens have been designed particularly for applications in the field of cinema and flight simulation. These screens are generally hemispherical or cylindrical. However, the projection of three-dimensional (3D) scenes, including objects defined by 3D modeling, on non-planar projection surfaces requires a correction of the geometric models of the objects to give a geometrically correct perception by the user. This process, called distortion correction or geometric correction, involves considerable computational complexity.

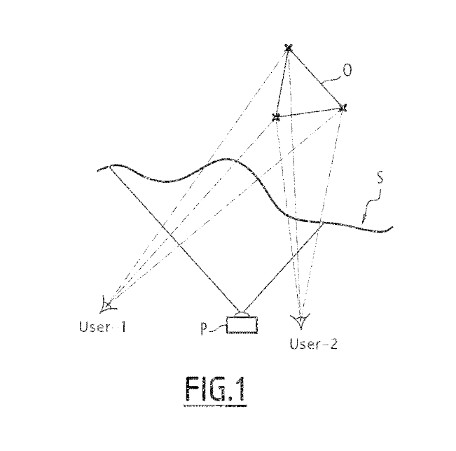

It should be noted that a user's perception of the geometry of a three-dimensional object projected onto a non-planar projection surface depends on the geometry of the display surface and the user's position, as schematically illustrated in FIG. 1.

FIG. 1 shows schematically, viewed from above, a display surface S of any curved shape, a projector P, an object O to be projected, as well as the positions of two users designated as User-1 and User-2, wherein each position is associated with the eyes of the respective user.

Several approaches have been proposed for displaying or rendering three-dimensional scenes on curved display surfaces.

The family of so-called ray tracing methods is well known, but these methods involve computational complexity that is too significant for real-time implementation.

The family of two-pass two-dimensional (2D) warped image rendering methods that is conventionally used to correct perspective in immersive systems, is not suitable for dynamic generation of the image to be displayed as a function of the position of the user.

U.S. Pat. No. 6,793,350 entitled “Projecting warped images onto curved surfaces” describes a three-dimensional rendering method belonging to the family of methods of transfer on quadric surfaces. This method describes the display of objects modeled by vector models that are defined by vertices. The method consists in modifying the spatial position in a 3D reference system of the vertices, so that the image generated by a conventional orthographic projection is correctly distorted according to the curvature of the projection surface and the position of the user. This method requires a calculation for each vertex of the 3D model, and is limited to quadratic (or quadric) display surfaces, modeled by a second degree equation. As a result, this method is limited to quadrically shaped display surfaces.

The object of the invention is to overcome the drawbacks of the state of the art by proposing a method of displaying three-dimensional scenes on a display surface which has an arbitrary non-planar shape, with distortion correction of the point of view of a user, and having computational complexity less than the previous methods.

For this purpose and according to a first aspect, the invention proposes, a three-dimensional scene display method on a non-planar arbitrary shaped display surface, for correct viewing by a user having a given position in a three-dimensional spatial reference system, wherein the method comprises displaying a display image having pixels representative of the three-dimensional scene.

The method comprises:
a first phase of projection in perspective of a three-dimensional model of the display surface on a projection plane, wherein the projection in perspective has a projection center depending on the position of the user in the spatial reference system, making it possible to obtain a projection image of the display surface from the point of view of the user,
a second phase of calculating a projection of the three-dimensional scene on the display surface using the projection image.

Advantageously, the three-dimensional scene display method on an arbitrary shaped display surface according to the invention makes it possible to carry out a distortion correction in order to make the display geometrically correct from the point of view of a user. The method according to the invention is not limited to quadrically shaped display surfaces, but may be applied to any form of display surface.

In addition, advantageously, the method according to the invention presents a limited computational complexity for displaying a three-dimensional scene regardless of the shape of the display surface.

The three-dimensional scene display method according to the invention may have one or more of the features below, taken independently or in any technically feasible combination.

The first phase comprises, for each point of a display space of the display image, obtaining the coordinates in the three-dimensional spatial reference system of a corresponding point of the display surface.

The method further comprises calculating a three-dimensional model of the display surface having the points of the display surface previously obtained.

The three-dimensional model of the display surface is a mesh, wherein the vertices of the mesh are defined by the previously obtained points of the display surface.

The method comprises the determination of the projection plane from the position of the user in the spatial reference system and the barycenter of the previously obtained points of the display surface.

It comprises the determination and storage of parameters representative of the perspective projection applied to the three-dimensional model of the display surface.

The first phase comprises a step of calculating and storing, for each coordinate point (s, t) of the projection image, a corresponding coordinate point (u, v) of the display image, wherein the coordinate point (u, v) is the point of the display image displayed at the coordinate point (x, y, z) of the display surface which is projected, by the projection, at the coordinate point (s, t) of the projection plane.

The second phase comprises the application of the perspective projection to a three-dimensional model of the scene to be displayed on the projection plane, and the recovery, from a stored correspondence table, of the coordinates of the corresponding display image point.

The three-dimensional model of the scene to be displayed is composed of primitives, wherein each primitive comprises a polygon defined by a set of first vertices and edges connecting the first vertices, wherein the method comprises a subdivision step by adding second vertices in each primitive as a function of a distance between the user and the first vertices.

According to a second aspect, the invention relates to a three-dimensional scene display device on an arbitrary non-planar shaped display surface for correct viewing by a user having a given position in a three-dimensional spatial reference system, wherein the device comprises means for displaying a display image having pixels representative of the three-dimensional scene. This device comprises:
a module capable of implementing a first projection phase in perspective of a three-dimensional model of the display surface on a projection plane, wherein the projection in perspective has a projection center depending on the position of the user in the spatial reference system, which makes it possible to obtain a projection image of the display surface from the point of view of the user,
a module capable of implementing a second phase of calculating a projection of the three-dimensional scene on the display surface using the projection image.

As the advantages of this display device are similar to those of the display method briefly described above, they are not recalled here.

According to a third aspect, the invention relates to a computer program comprising instructions for carrying out the steps of a three-dimensional scene display method on a display surface of an arbitrary shape as briefly described above, upon the execution of the program by at least one processor of a programmable device.

Other characteristics and advantages of the invention will emerge from the description which is given below, by way of indication and in no way limitative, with reference to the appended figures, wherein:

FIG. 1 (already described) shows schematically the problem of displaying a 3D object on a display surface of an arbitrary shape;

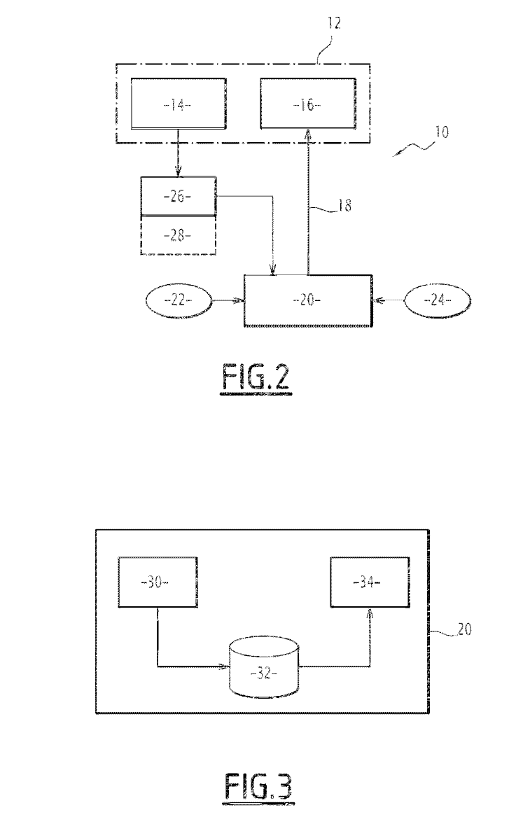

FIG. 2 shows a block diagram of a 3D scene display system according to one embodiment of the invention;

FIG. 3 shows a block diagram of a programmable device adapted to implement a three-dimensional scene display method;

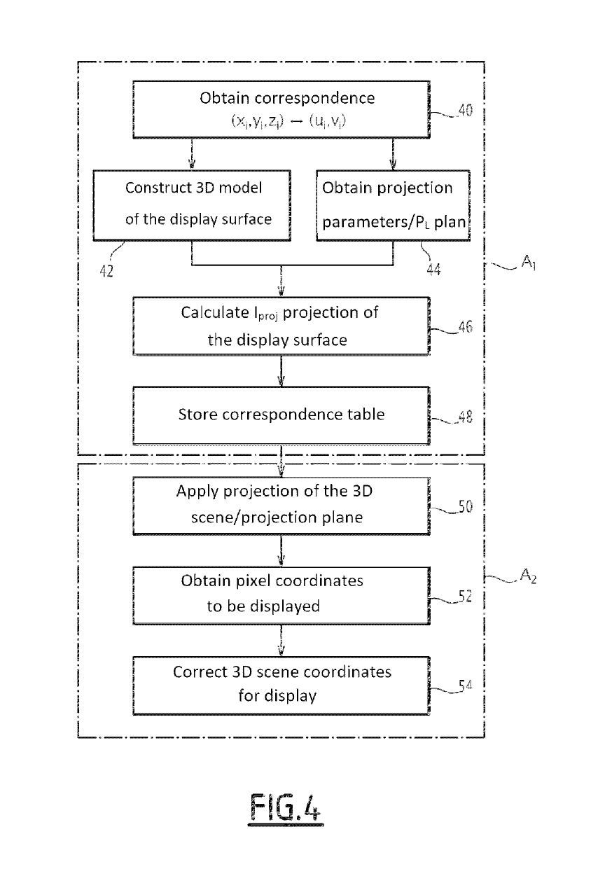

FIG. 4 shows a flowchart of the main steps of a 3D scene display method according to one embodiment of the invention;

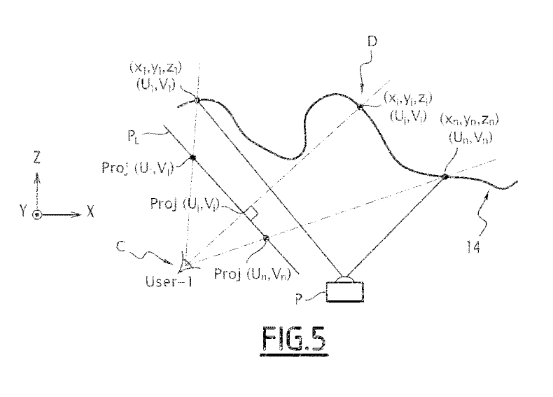

FIG. 5 shows schematically the projection in perspective of a mesh of a curved display surface;

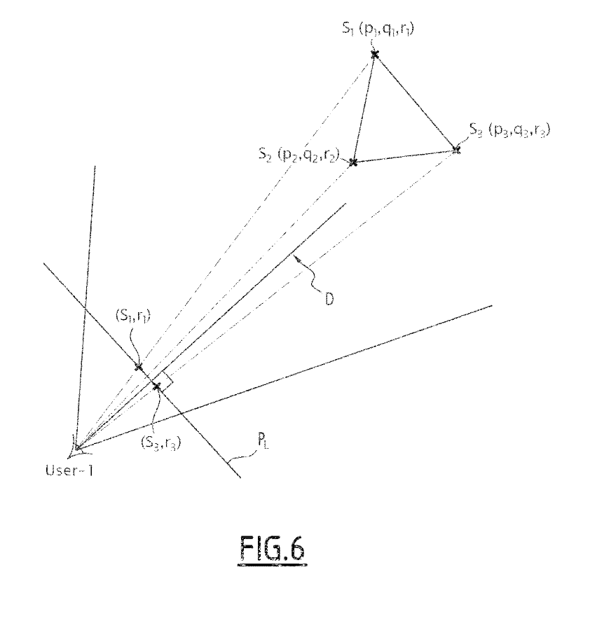

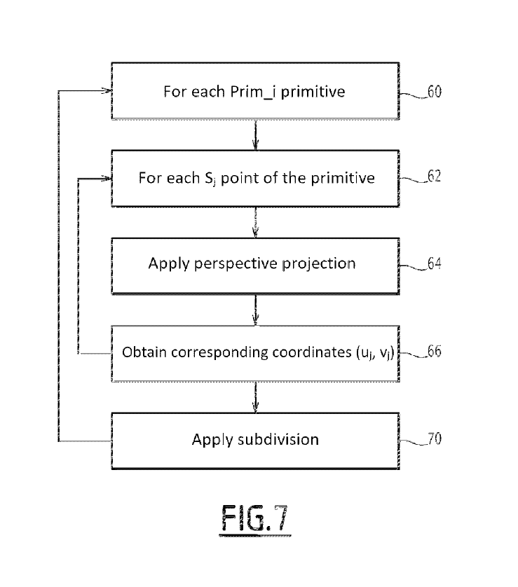

FIG. 6 shows schematically the projection in perspective of a 3D modeling of a 3D object to be displayed;

FIG. 7 shows a flowchart of the main steps of the projection on the display surface of a 3D scene according to one embodiment.

The invention is described hereinafter in its application for a 3D scene display having an associated three-dimensional model. A 3D scene is composed of one or more objects to be displayed, wherein each object is described by geometric primitives (for example triangles) associated with parameters (texture values, color, . . . ).

It should be noted that the application of the invention is not limited to a system for projecting 3D scenes on a display surface with an arbitrary curved shape, but is generally applicable to any display system on an arbitrary curved surface, for example a curved LCD screen. The invention also applies to displays with distorted pixels, for example a projector system provided with distorting lenses.

In other words, the invention is applicable for a three-dimensional scene display on an arbitrary non-planar shaped display surface, potentially equipped with distorting optics.

FIG. 2 shows a block diagram of a display system 10 capable of implementing the invention.

The system 10 includes a display system 12 of 3D scenes on an arbitrary non-planar shaped display surface.

The display system 12 comprises a display surface 14 on which display images 18 are displayed on a display unit 16.

In one embodiment, the display surface 12 is a curved projection surface, and the display unit 16 is a projector.

Alternatively, the elements 14 and 16 are integrated in a curved LCD screen.

The display system 12 receives a display image 18 defined by one or more matrices of pixels to be displayed, wherein each pixel has a colorimetric value and is located at a position defined by a line index u and a column index v of the matrix. A display space E={(u, v),0≤u<M,0≤v<N} is defined for a display resolution of M lines and N columns.

It should be noted that the display system 12 is able to display a video stream composed of a plurality of successive display images.

The display images 18 are calculated by a programmable device 20, for example a computer or a graphics card, comprising one or more GPU processors and associated memories.

The programmable device 20 receives as input a spatial position 22 associated with the user's eyes in a given 3D reference system, making it possible to define the user's field of vision.

The position of the eyes of the user is provided by any known tracking system.

The programmable device 20 also receives as input a representation 24 of the scene to be displayed, comprising a 3D modeling of the scene to be displayed.

The system 10 further comprises a unit 26 for capturing the 3D geometry of the display surface 14.

In one embodiment, the unit 26 is a time of flight (TOF) camera for measuring in real time a three-dimensional scene.

Alternatively, the acquisition may be performed by a stereoscopic device.

According to another variant, when the elements 14 and 16 are integrated in an LCD screen and the spatial position of the pixels is known, for example by using a deformable optical fiber grating, wherein the unit 26 is integrated and allows the acquisition of the geometry of the display surface.

It should be noted that the unit 26 has been shown separately, but in one embodiment, when the display device 12 comprises a projector 16, the unit 26 is a TOF camera mounted near the projection optics of the projector 16. Preferably, a conventional optical camera 28 is also present and is likewise embedded near the projection optics in one embodiment.

The joint use of a TOF camera 26 and an optical camera 28 makes it possible to find parameters for mapping each position (u, v) of the display space, associated with the display image, with a corresponding coordinate point (x, y, z) of the display surface 14.

FIG. 3 shows a block diagram of the main functional modules implemented by a programmable device 20 capable of implementing the invention.

The device comprises a first module 30 capable of implementing a perspective projection of a three-dimensional model of the display surface on a projection plane, wherein the perspective projection has a projection center depending on the position of the user in the spatial reference system, which makes it possible to obtain a planar projection image of the display surface from the point of view of the user.

It also comprises a memory 32, in which are stored various parameters of the method, and in particular a correspondence table which associates the position (u, v) corresponding to the projected point of coordinates (x , y, z) of the display surface 14, with each point of the projection image.

The device 20 also comprises a second module 34 capable of implementing the calculation of a projection of the three-dimensional scene on the display surface using the projection image.

FIG. 4 shows a block diagram of the main steps of a three-dimensional scene display method according to one embodiment of the invention.

These steps are preferably implemented by a graphics processor unit (GPU) of a programmable device.

The method comprises two phases in the embodiment.

A first phase A1 for projection of the display surface from the point of view of the user is implemented during a change of shape of the display surface or during a change of position of the user

The data provided at the end of this phase are stored for use in a second phase A2 for projection of the 3D scene to be displayed.

Preferably, the geometry of the 3D objects to be displayed is represented in the form of a model comprising a list of vertices thus making it possible to define a plurality of polygonal faces of these objects.

Advantageously, the execution of the second phase A2 is performed in linear calculation time with respect to the number of vertices of the modeling.

In the embodiment of FIG. 4, the first phase A1 comprises a first step 40 for recovering the spatial coordinates (x, y, z), represented in a given frame (X, Y, Z), of the surface d display associated with the pixels (u, v) of the display space of the display device.

FIG. 5 shows schematically this correspondence in one embodiment in which the display system includes a projector.

FIG. 5 shows schematically a display surface of an arbitrary curved shape 14 (seen from above) and a projector P, as well as a spatial reference system (X, Y, Z).

A coordinate point (xᵢ, yᵢ, zᵢ) of the display surface 14 corresponds to each point (uᵢ, vᵢ) of the display space.

Following step 40, the step 42 for constructing a 3D model of the display surface and the step 44 for determining perspective projection parameters are implemented.

In the preferred embodiment, steps 42 and 44 are implemented substantially in parallel.

In one embodiment, a Delaunay triangulation is applied to step 42 by taking as vertices the previously determined points using their coordinates (uᵢ, vᵢ). The result is a display surface represented by a mesh of triangles of these points by considering their associated coordinates (xᵢ, yᵢ, zᵢ).

Alternatively, other 3D modelings known in the field of computer graphics may be used, for example non-uniform rational B-splines (NURBS) or a Bezier surface, by using the previously determined points (xᵢ, yᵢ, zᵢ) as checkpoints.

Step 44 determines the perspective projection parameters and an associated projection plane P_{L}. The points (x, y, z) corresponding to the pixels (u, v) of the display space are used in step 44.

The perspective projection parameters take as the projection center the spatial coordinates of a spatial position of the user's eyes in the spatial reference frame (X, Y, Z) as defined in step 44. Therefore, the center of projection is directly related to the spatial position of the respective user.

A projection plane P_{L} associated with this projection in perspective is defined.

Preferably, the projection plane PL is a plane perpendicular to the line D passing through the projection center C and the mesh point of the display surface closest to the barycenter of the mesh.

It should be noted that mathematically, it is sufficient to consider a plane P_{L} not passing through the center of projection C.

FIG. 5 shows schematically such a projection plane P_{L} and the points respectively denoted Proj(uᵢ, vᵢ) of the plane P_{L}, corresponding to the projection of the points (xᵢ, yᵢ, zᵢ) of the spatial reference system associated with the pixels (uᵢ, vᵢ) of the display space.

This projection plane thus defined makes it possible to store a rectangular two-dimensional projection image Iₚᵣₒⱼ of the display surface from the point of view of the user, defined by coordinate points (s, t), as well as coordinates of the pixels of the corresponding display space.

The projection plane P_{L} is chosen so that the perspective projection of the display surface takes up maximum space in the two-dimensional projection image.

The endpoints of the two-dimensional projection image are calculated by performing a first projection pass and selecting the minimum and maximum coordinates on the projection axes.

The resolution of the two-dimensional projection image is greater than or equal to the resolution of the image to be displayed, and preferably equal to twice the resolution of the image to be displayed, in order to minimize artefacts perceptible to the user.

Preferably, when the display space corresponds to a display image of M×N pixels, the projection image has a resolution of 2M×2N:

Iₚᵣₒⱼ(s, t),0≤s<2M,0≤t<2N.

The parameters of the perspective projection determined in step 44 are stored. These parameters comprise the spatial coordinates of the projection center C as well as those of the frustum associated with the projection: i.e. the distance between the projection plane and the projection center C, wherein the coordinates of the endpoints define the cone of vision from the point of view of the user.

The step 44 for obtaining the projection parameters is followed by a step 46 for calculating the perspective projection of the 3D modeling of the display surface obtained in step 42 with the perspective projection parameters defined at step 44.

At each point (s, t) of the projection image, the coordinates (u, v) in the display space of the pixel of the display device corresponding to the point (x, y, z), are obtained by interpolation of the projected display surface.

The calculation of step 46 is followed by the storage in a correspondence table of the coordinates (u, v) calculated during the storage step 48.

The calculated coordinates (u, v) are stored for each point (s, t).

In one embodiment, the correspondence table is stored in a buffer of the programmable device implementing the method.

The first phase A1 of the process is completed.

The second phase A2 comprises a step 50 for applying the perspective projection with the projection parameters calculated during step 44 and stored as a 3D model of the scene to be displayed.

The perspective projection is applied to the vertices of the 3D modeling of the scene. Each vertex of the 3D modeling of the spatial coordinates scene (pᵢ, qᵢ, rᵢ) is projected at a point (sᵢ, tᵢ) of the projection image.

By way of example, FIG. 6 shows schematically the projection of the vertices S, of an object (seen from above) on the previously determined projection plane PL, with the projection center C depending on the position of the gaze of the eye of the User-1.

The perspective projection 50 is followed by the step 52 for obtaining the coordinates (u, v) corresponding to the respective points (s, t), using the correspondence table previously stored, indicating the pixel coordinates of the display space to be related to the coordinate vertex (p, q, r) so that the display is effected correctly from the point of view of the user.

The implementation of this step simply comprises access to the correspondence table.

Advantageously, obtaining the correspondence of the coordinates is linear as a function of the number of vertices defining the 3D scene to be displayed, regardless of the shape of the display surface.

Step 52 is followed by the step 54 for geometric correction of the coordinates (p, q, r) of each vertex to be displayed as a function of the coordinates (u, v) obtained at the step 52 and the distance of the eye of the user to the respective vertex.

The use of this distance makes it possible to preserve correct data for the occlusion calculation by using a depth buffer method (Z-buffer).

In one embodiment, in the second phase A2 of the method, the geometric modeling of the objects to be displayed is dynamically adapted to improve the visual rendering by tessellation. The level of tessellation is adapted according to the distance separating the projection on the plane P_{L} of two vertices of a same geometric primitive of the 3D scene to be displayed.

In the embodiment described with reference to FIG. 7, the tessellation applies to each primitive of the 3D modeling of the scene. A primitive of the 3D modeling comprises a polygon defined by a set of vertices, for example three vertices in the case of a triangle.

The tessellation then comprises the following steps for each primitive of the 3D modeling of the scene.

For each Prim-i primitive of the 3D modeling (step 60), and for each vertex Sj of Prim-i (step 62), the perspective projection is applied to the step 64, analogously to the step 50 described above.

In step 66, the corresponding coordinates (uᵢ, vᵢ) are obtained from the correspondence table, analogously to the step 52 described above.

In step 70, the choice is made to apply a more or less significant subdivision of the treated Prim-i primitive, as a function of the maximum distance Dmax between the points (uᵢ, vᵢ). The greater the latter, the stronger the subdivision of the primitive.

In one embodiment, subdivision will not be applied if Dmax<Dseuil_min where Dseuil_min a predetermined minimum threshold distance, a subdivision number equal to Subdiv_max if Dmax>Dseuil_max, where Dseuil_max is a predetermined maximum threshold distance greater than Dseuil_min, and a number of subdivisions equal to floor((Dmax−Dseuil_min)/(Dseuil_max−Dseuil_min)*Subdiv_max if not.

The minimum and maximum threshold distance values are selected based on the resolution to be displayed.

For example, for the standard full HD resolution, Dseuil_min=20 pixels and Dseuil_max=400 pixels may be used. These values are given by way of a non-limiting example.

Step 70 is followed by the step 60 previously described for the treatment of another primitive of the 3D modeling.

After subdivision, the steps 50 to 54 previously described are applied.

The invention is advantageously applicable whatever the display surface, in particular without limitation to the display surfaces that may be modeled by a Cartesian or other mathematical equation. It applies in particular, as explained above, in the case of a projector with distorting lenses or flexible screens. The invention is advantageously implemented when there is no intrinsic modeling matrix of a projector-camera system, i.e. when the projector-camera system is not parameterizable by linear equations.

1. A method for displaying a three-dimensional scene on a display surface of an arbitrary non-planar shape, for correct visualization by a user having a given position in a three-dimensional spatial reference system, wherein the method comprises displaying a display image comprising pixels representative of the three-dimensional scene,
the method further comprising:
a first phase of projecting in perspective a three-dimensional model of the display surface on a projection plane, wherein the perspective projection has a projection center depending on the position of the user in the spatial reference system, making it possible to obtain a projection image of the display surface from the point of view of the user, and
a second phase of calculating a projection of the three-dimensional scene on the display surface using the projection image.

2. The method for displaying according to claim 1, wherein the first phase comprises:
for each point of a display space of the display image, obtaining coordinates in the three-dimensional spatial reference system of a corresponding point of the display surface.

3. The method for displaying according to claim 2, it further comprising calculating a three-dimensional model of the display surface comprising the previously obtained points of the display surface.

4. The method for displaying according to claim 3, wherein the three-dimensional model of the display surface is a mesh, wherein the vertices of the mesh are defined by the previously obtained points of the display surface.

5. The method for displaying according to claim 2, comprising determining the projection plane from the position of the user in the spatial reference system and the barycenter of the previously obtained points of the display surface.

6. The method for displaying according to claim 5, comprising determining and storing of parameters representative of the perspective projection applied to the three-dimensional model of the display surface.

7. The method for displaying according to claim 1, wherein the first phase comprises calculating and storing of each coordinate point (s, t) of the projection image, a corresponding coordinate point (u, v) of the display image, wherein the coordinate point (u, v) is the point of the display image displayed at the coordinate point (x, y, z) of the display surface which is projected at the coordinate point (s, t) of the projection plane.

8. The method for displaying according to claim 7, wherein the second phase comprises applying the perspective projection to a three-dimensional model of the scene to be displayed on the projection plane, and recovering the point coordinates (u, v) of the corresponding display image from a stored correspondence table.

9. The method for displaying according to claim 8, wherein the three-dimensional model of the scene to be displayed is composed of primitives, wherein each primitive comprises a polygon defined by a set of first vertices and edges connecting the first vertices, wherein the method comprises subdividing by adding second vertices in each primitive, as a function of a distance between the user and the first vertices.

10. A device configured for displaying a three-dimensional scene display device on an arbitrary non-planar shaped display surface, for correct viewing by a user having a given position in a three-dimensional spatial reference system, wherein the device comprises a display for displaying an image display comprising pixels representative of the three-dimensional scene, comprising:
a module capable of implementing a first perspective projection phase of a three-dimensional model of the display surface on a projection plane, wherein the perspective projection has a projection center depending on the position of the user in the spatial reference system, making it possible to obtain a projection image of the display surface from the point of view of the user, and
a module capable of implementing a second phase of calculating a projection of the three-dimensional scene on the display surface using the projection image.

11. A computer program comprising instructions for implementing the steps of a three-dimensional scene display method on an arbitrary non-planar shaped display surface according to claim 1 upon executing the program, by at least one processor of a programmable device.
